(19) United States
(12) Patent Application Publication
(10) Pub. No.: US 2021/0007553 A1
(43) Pub. Date: Jan. 14, 2021

(54) PACKAGING FOR HEATING A PRODUCT, ELECTROMAGNETIC INDUCTION FURNACE AND HEATING METHOD

(71) Applicant: SOCIÉTÉ GÉNÉRALE D' EQUIPEMENT DE RESTAURATION, Chapareillan (FR)

(72) Inventor: Gérard RAFFAELE, Goncelin (FR)

(73) Assignee: SOCIÉTÉ GÉNÉRALE D' EQUIPEMENT DE RESTAURATION, Chapareillan (FR)

(21) Appl. No.: 16/925,058

(22) Filed: Jul. 9, 2020

(30) Foreign Application Priority Data
Jul. 9, 2019 (FR) 1907701

(51) Int. Cl. A47J 39/00; B32B 27/10; A47J 36/26

(52) U.S. Cl. CPC A47J 39/006; B32B 2439/70; A47J 36/26; B32B 27/10

(57) ABSTRACT

Packaging for a food product has a box made from cardboard material with a base and a lid. The lid is fitted pivoting around a hinge fixed to the base. An electrically conducting foil is installed so as to separate the food product and the base. The lid is cut by a cutting line extending to define a central area and a peripheral area each arranged pivotally with respect to the base. The central area is inscribed inside the peripheral area. The central area is facing the electrically conducting foil and extends partly in a front side panel of the lid opposite the side panel supporting the hinge.

### BACKGROUND OF THE INVENTION

The invention relates to an electromagnetic induction furnace, to a packaging for heating a product collaborating with one such furnace, and to a heating method.

### STATE OF THE ART

It is known to use a product installed in a packaging that is to collaborate with an electromagnetic induction furnace. The product to be heated or reheated is installed in the packaging. The packaging comprises a cardboard packaging provided with a base and a lid fitted movable by pivoting to close the packaging. The cardboard packaging is of rectangular shape.

The packaging also comprises two aluminium trays for storing the product to be heated. The product is disposed between the two aluminium trays. The two aluminium trays join one another to form a closed volume containing the product.

When the packaging is inserted in the furnace, it is important to respect the relative position of the packaging with respect to the two inductors to obtain a correctly distributed heating. To make this product easy to use, the packaging is inserted closed in the heating area thereby avoiding any handling operation of the aluminium trays outside the cardboard packaging.

This has the result that, when the product is heated, the heat input does not spread uniformly in the packaging so that the lid burnishes in contact with the upper aluminium tray. Burnishing of the lid reflects a negative image as regards the heating step and the product contained in the packaging. When the heating device is not an inductor collaborating with the upper tray, the cardboard lid acts as a thermally insulating film which means that a larger quantity of energy has to be applied to heat the product.

### OBJECT OF THE INVENTION

One object of the invention consists in providing a packaging for a food product designed to operate in conjunction with an induction furnace. The packaging enables heating of the product to be better controlled, while remaining simple to use and providing a good strength.

The packaging for a food product comprises:
a box made from cardboard material provided with a base and a lid, the lid being arranged pivotally around a hinge fixed to the base between a closed position and an open position, the lid having a top main panel facing a bottom main panel of the base in the closed position and side panels,
an electrically conducting foil fitted so as to separate the food product and base.

The packaging is remarkable in that the lid is cut to define a central area and a peripheral area each arranged so as to be able to pivot independently with respect to the base, the peripheral area being arranged pivoting around the hinge, the central area being arranged pivotally with respect to the peripheral area and being inscribed inside the peripheral area, the central area being facing the electrically conducting foil and extending partly in a front side panel of the lid opposite the side panel supporting the hinge of the peripheral area or in a rear side panel of the lid supporting the hinge of the peripheral area, the central area representing at least 50% of the surface of the top main panel of the lid.

In one development, the central area and the peripheral area are arranged pivoting around one and the same hinge.

It is a further object of the invention to provide an electromagnetic induction furnace enabling optimum and rapid heating of the meal to be heated to be obtained while at the same time avoiding impairing the appearance of the packaging and/or reducing the energy losses. The furnace is an induction furnace to heat a product placed in a packaging provided with a base associated with a lid that is movable by pivoting with respect to the base. The electromagnetic induction furnace comprises:
a housing defining an insertion slot for inserting the packaging into a heating area,
a bottom inductor and a heating device arranged in the housing and spaced apart from one another to define the heating area.

The induction furnace is remarkable in that it comprises a detector configured to detect whether the lid of the packaging is present or not, the detector being configured to prevent electric power supply of the bottom inductor and of the heating device when the detector detects that the lid of the packaging is present in the heating area and to allow power supply of the bottom inductor and of the heating device when the detector detects that the lid is not present in the heating area, the detector comprising a movable pin, a control circuit monitoring the movement of the movable pin to deduce the presence or absence of the lid in the heating area therefrom.

In one development, the movable pin moves in the heating area in a direction passing via the bottom inductor and the heating device.

Advantageously, the housing defines a guide configured to guide the packaging from the slot to the heating area in a first direction, the movable pin moving in the heating area in the first direction, the movable pin being associated with a spring pushing the movable pin in the direction of the slot so that insertion of the packaging presses on the movable pin.

In an alternative embodiment, the induction furnace comprises:
a housing defining an insertion slot for inserting the packaging into a heating area,
a bottom inductor and a heating device spaced apart from one another to define the heating area.

The induction furnace is remarkable in that it comprises an error prevention device forming a part of the insertion slot, the error prevention device extending from the top surface of the insertion slot to the bottom surface of the insertion slot to prevent insertion of the packaging when the lid is in a position closing the packaging.

It is a further object of the invention to provide a heating method of a product in a packaging made from cardboard material that is energy-efficient and/or that reduces damage of the cardboard material.

The method is remarkable in that it comprises the following steps:
providing a packaging according to one of the foregoing embodiments in the closed position,
providing a furnace according to one of the foregoing embodiments,
moving the central area from the closed position to the heating position, the peripheral area being in the closed position,
inserting the base and the product in the heating area of the induction furnace by passing through the insertion slot, the central area being outside the heating area,
heating the product.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates an induction furnace provided with an error prevention device on the insertion slot of the packaging, in front view;

FIG. 2 schematically represents an induction furnace provided with a pin movable vertically in the heating area, in front view;

FIG. 3 schematically represents an induction furnace provided with a pin movable longitudinally in the heating area, in longitudinal cross-section;

FIG. 4 schematically represents a packaging in the closed position and not containing any metal trays;

FIG. 5 schematically represents a packaging in the open position and not containing any metal trays.

### DESCRIPTION OF THE EMBODIMENTS

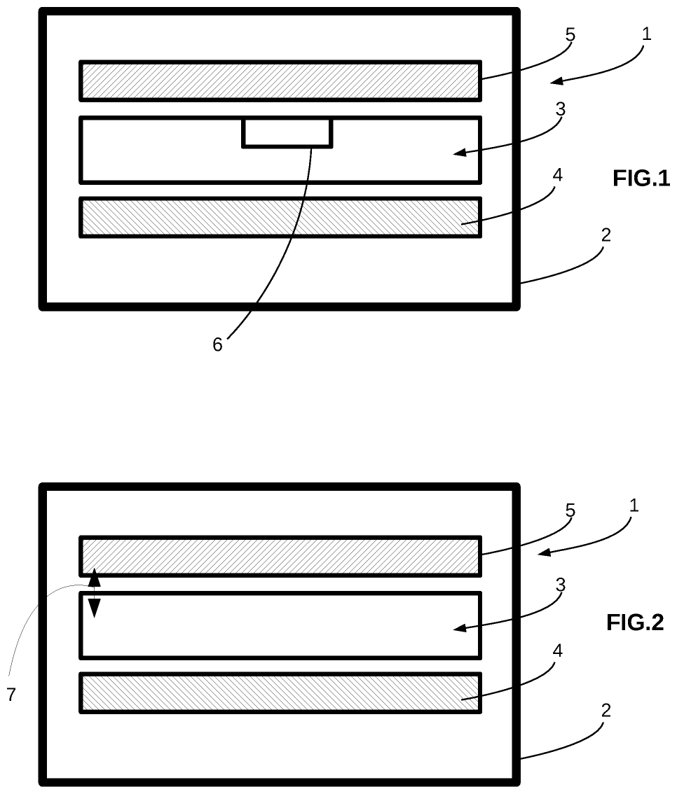

With reference to FIGS. 1 to 3, an electromagnetic induction furnace 1 comprises a housing 2 defining an insertion slot 3 for inserting a packaging 10 into a heating area. A bottom electromagnetic inductor 4 and an upper heating device 5 are arranged in housing 2. Bottom electromagnetic inductor 4 and upper heating device 5 are spaced apart from one another by a distance allowing insertion of a packaging receiving a product to be heated or reheated. The product is a food product. Inductor 4 and heating device 5 are facing one another and are spaced apart from one another to define the heating area receiving packaging 10 and therefore the product to be heated. Inductor 4 and heating device 5 are facing one another in a vertical direction.

Packaging 10 comes in the form of a box and is also called box. The box forms a rectangle.

Upper heating device 5 can be an electromagnetic inductor or a radiant heating device having a resistance and/or an infrared heating device. Inductor 4 is advantageously a horizontal inductor and the same is advantageously the case for heating device 5.

Furnace 1 can form part of an automatic distributor of products arranged in a packaging 10, in particular pizzas or pies.

The furnace is configured so that insertion slot 3 of packaging 10 ensures that packaging 10 is inserted horizontally between inductor 4 and heating device 5. Inductor 4 and heating device 5 are advantageously separated by support sections in order to define the separating distance designed to receive packaging 10. The furnace comprises a guide designed to guide the packaging from slot 3 to the heating area. The guide defines a first direction of movement of packaging 10.

Inductor 4 comprises a flat coil supported by a support plate made from insulating material. Inductor 4 is electrically connected to a supply generator (not shown), for example of the type described the document FR 2818499, to generate an electromagnetic induction in the heating area when excited. Heating device 5 is also associated with a supply generator providing heating device 5 with electric power. The supply generator of the heating device can be identical to or different from that of inductor 4.

Packaging 10 comprises a box made from cardboard material in which the pizza or any other product to be heated is inserted. The box is rectangular-shaped. The box comprises a base 11 articulated by a fold line 12 on a fold-down lid 13. Fold line 12 forms a hinge between base 11 and lid 13. A bottom foil 14 made from an electrically conducting material, for example a metal foil, is installed in the box so as to separate the product to be heated and base 11. The bottom foil is referred to in the following as bottom metal foil 14. Inductor 4 is supplied with electric current enabling the metal foil to be heated. The input of calories to bottom metal foil 14 enables the product to be heated. Bottom metal foil 14 advantageously presents the form of a tray with lips. Bottom metal foil 14 is fitted removable with respect to the box.

Bottom metal foil 14 is for example an aluminium foil. The product is for example a pizza contained in an aluminium tray, the whole being placed on base 11 inside the box.

For ease of handling of the product, the product is kept as long as possible in the box and on base 11. When the product is heated, lid 13 is not in contact with the product so as to protect the top surface of the product. The same is advantageously the case during handling of the latter. It also appears advantageous to have heating of the product in box 1 as this facilitates handling of the hot product. After heating, bottom metal foil 14 is hot, and it is therefore preferable to carry the product by means of the box and in particular via base 11 made from cardboard material. It is also advantageous to be able to use lid 13 to close box 1 and keep the product warm longer.

To prevent damage to lid 13, heating of the product is performed with lid 13 in the open position or in the heating position. It is particularly advantageous to perform insertion of packaging 10 with lid 13 in the heating position and to have a slot 3 and a heating area preventing lid 13 from being inserted in the heating area in the open position. The distance between inductor 4 and heating device 5 is smaller than the length of the top surface of box 1, i.e. the distance between the hinge and the opposite front surface of box 1. When the product is heated, lid 13 is outside the heating area, preferably against the front surface of housing 2 defining slot 3.

In a particular configuration, in addition to bottom metal foil 14, the packaging comprises a top metal foil 15. The bottom metal foil and top metal foil together define a volume receiving the product. Bottom metal foil 14 is heated by means of inductor 4. Top metal foil 15 can be heated by heating device 5 which is of inductive type. Top metal foil 15 is not fixed to the box.

In this configuration, the calories input to top metal foil 15 are not transmitted to lid 13 and only serve the purpose of heating the volume bounded by the two metal foils and containing the product to be heated. This also results in lid 13 not being arranged to block a part of the calories emitted by heating device 5 in the direction of the top surface of the product to be heated.

To prevent the heating operation of the product from being performed with lid 13 in the closed position, i.e. with lid 13 closing box 1, the furnace can be provided with an error prevention device 6 preventing insertion of a closed box and/or the furnace is provided with a detector configured to detect whether the lid is present in the heating area or not. FIG. 1 illustrates a furnace provided with an error prevention device 6 on slot 3. In advantageous manner, error prevention device 6 is distinct from the heating means to make error prevention device 6 easy to clean. It is also advantageous to have an error prevention device 6 that is electrically dissociated from the heating means. In preferential manner, error prevention device 6 is fitted upstream from the heating means so as to prevent the box from entering the furnace and coming into contact with the heating means when the box is in the closed position.

The use of an error prevention device 6 is particularly advantageous in collaboration with a box 1 comprising a notch on the front panel arranged to allow error prevention device 6 to pass through. The front panel of the box is the panel opposite the side panel comprising the hinge. In the prior art, insertion slot 3 is of rectangular shape and the dimensions of the slot are larger than those of the box in the closed position to make it easier to place products in the heating area. Error prevention device 6 temporarily reduces the height of slot 3 to prevent insertion of a closed box. The notch represents a reduction of the height of the front side panel of the box which is representative of a box with a lid in the open position or in the heating position. In an advantageous embodiment, error prevention device 6 extends up to the height or under the height of upper heating device 5.

In a particular embodiment that is either an alternative or can be combined with the previous embodiment, the furnace comprises a detector configured to detect whether lid 13 is present in the heating area or not. When the detector detects the presence of lid 13 in the heating area, it disables the power supply of inductor 4 and the power supply of heating device 5. Detection of lid 13 prevents actuation of heating device 5 so as to prevent top metal foil 15 from generating calories and thereby to prevent lid 13 from being damaged when the heating device is an inductor. The same is the case when heating device 5 is radiant or an infrared radiation device as lid 13 blocks the radiation from heating device 5 to the product. The heating is more efficient.

When the detector detects that lid 13 is not present in the heating area, it enables power supply of inductor 4 and power supply of heating device 5. Heating of the product can be performed.

The detector can take different forms to detect the absence or presence of lid 13 folded onto the base of box 1, i.e. in the closed position. It is advantageous to use a pin 7 fitted movable in housing 2, in or close to the heating area, movement of pin 7 being linked to the presence or absence of lid 13.

In a particular embodiment, the furnace is provided with a pin 7 fitted in movable manner and configured to detect a difference of shape in the packaging depending on whether lid 13 is in the closed position, in the open position or in the heating position. Pin 7 can detect the presence of the notch which is representative of the lid in the open position or in the heating position.

As illustrated in FIG. 2, pin 7 can be fitted movable with a substantially vertical movement or a vertical component so as to come into contact with the lid before coming into contact with the base. The movement of the pin can be a translation or a rotation so as to come into contact with the bottom surface of base 11. For example, pin 7 moves vertically and the value of extension of the pin enables the presence or absence of lid 13 to be detected in a direction connecting inductor 4 and heating device 5. This embodiment does however present the drawback of having a pin 7 that can come into contact with the product or with the top metal foil during its vertical movement towards the base of the packaging. This also requires provision of a device for moving pin 7. To prevent contact with the product, it is possible to fit pin 7 in one corner of the box, but this requires the use of boxes that are always substantially the same size, imposes the use of a product that does not move inside the box and means that insertion of the box in the heating area has to be perfectly mastered.

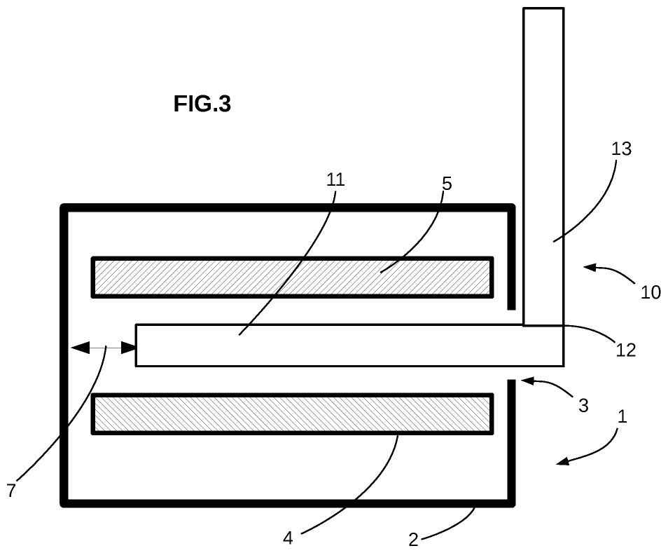

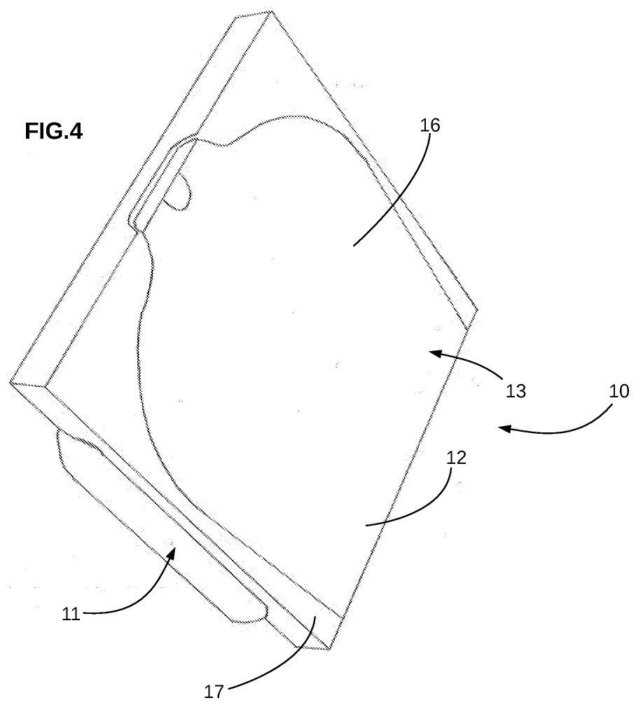

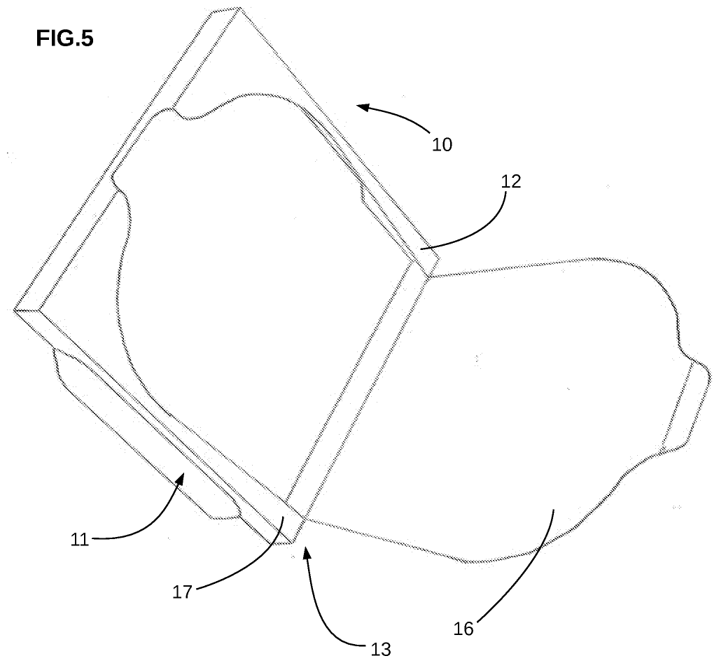

In another embodiment illustrated in FIG. 3, pin 7 is fitted movable in translation in a horizontal or substantially horizontal direction. When the user inserts the packaging in the heating area, the packaging presses on pin 7 or not, which makes it possible to detect insertion of the packaging in the heating area with a lid in the open position or in the closed position or in the heating position. There again, this imposes having a packaging the depth and positioning of which in the heating area are perfectly mastered to detect that the lid is not present. The translation can be replaced by a rotation.

It is advantageous to have a packaging having side panels of base 11 defining a different pattern from the pattern defined by the side panels of lid 13. Pin 7 is arranged facing a difference between the patterns of the two side panels, for example the notch indicated in the foregoing. The difference of pattern is detected by a difference of depression of pin 7. In advantageous manner, when lid 13 is in the closed position, pin 7 comes into contact with lid 13 and is depressed. When lid 13 is in the open or heating position, pin 7 is facing an empty area and is not depressed. Depression or the absence of depression makes it possible to differentiate a lid in the open position or in the heating position and a lid in the closed position. Pin 7 is associated with a spring connected on the one hand to pin 7 and on the other hand to housing 2. The spring is configured to obtain extension of pin 7 and to oppose depression of pin 7 when the packaging is inserted in the heating area. The spring pushes movable pin 7 towards slot 3.

In an alternative embodiment, pin 7 is depressed over a different distance between the open or heating positions and the closed position. This embodiment is more difficult to implement as it depends on the depression of the packaging inside housing 2 which can vary depending on the users and depending on the dimensions of packaging 10.

The use of an error prevention device 6 is particularly advantageous as error prevention device 6 is mounted fixed and defines the shape of slot 3 so that the user immediately understands that packaging 10 in the closed position will not be able to be inserted in the heating area.

In a particular embodiment, in order to enhance the strength of box 10 when the latter is inserted in and extracted from the heating area, it is advantageous to define a heating position instead of the open position of box 10. It is advantageous to cut the top panel of box 10 to define two portions of the lid differentiating between the open position and the heating position. It is advantageous for the cutting of the top panel of box 10 to extend up to a part of the front panel.

Base 11 has a bottom main panel designed to be covered by metal foil 14 and designed to support the product to be heated. Base 11 also has side panels joined to one another and to the bottom main panel to ensure a sufficient strength. However the strength procured by the base may be insufficient when box 10 is in the open position which means that the user has to support the underneath of box 10 which is hot. It is therefore advantageous to provide a configuration in which the box presents an enhanced strength while enabling box 10 to be heated.

Lid 13 has a top main panel, and side panels joined to one another and to the top main panel to ensure a sufficient strength. In the closed position, the side panels of lid 13 and of base 11 come into contact and limit deformation of box 10 due to the weight of the product.

The base defines a receiving area bounded by the side panels. Depending on the configurations, in the closed position, lid 13 can be arranged inside the receiving area or outside the receiving area.

As illustrated in the figures, lid 13 presents a cutting of the top main panel that extends up to the front surface of packaging 10.

The cutting defines a central area 16 and a peripheral area 17 which are both arranged pivotally for example by means of the hinge. Central area 16 and peripheral area 17 can pivot independently from one another and the hinges can be identical or different. Central area 16 is inscribed inside peripheral area 17. Peripheral area 17 comprises the three side panels in addition to the panel forming the hinge. Peripheral area 17 has a mechanical continuity by means of the different side panels thereby improving the strength of the box. Central area 16 is separated from the peripheral area by a cutting line.

The front panel of base 11 is cut so as to cooperate with error prevention device 6 or facilitate detection of lid 13 in the closed position. The cut area of the front part of lid 13 is facing the cut (i.e. eliminated) area of base 11.

In the open position, central area 16 and peripheral area 17 of lid 13 have pivoted with respect to the base in order to leave free access to the inner part of box 1. This position is used to insert the product to be heated. Preferentially, the product to be heated is installed between two metal films and the two metal films are handled so as not to handle the product directly.

The packaging is then reclosed. In the closed position, central area 16 and peripheral area 17 of lid 13 have pivoted with respect to base 11 around the hinge so as to close box 1. Lid 13 comes into contact with base 11. Lid 13 presses on base 11 to protect the product when the box is handled. Central area 16 is facing the product in a perpendicular direction to the bottom main panel.

In the heating position, central part 16 pivots with respect to base 11 and to peripheral area 17 so as to no longer cover the product to be heated. For example, central part 16 is arranged perpendicularly to the bottom main panel. In the heating position, peripheral area 17 is in an identical position to the closed position so that the multiple side panels of lid 13 come into contact with the side panels of base 11 or with bottom main panel giving box 1 a good mechanical strength. The portion of the top main panel of peripheral area 17 also plays a role in enhancing the strength of box 1 in the closed position and in the heating position.

Central part 16 that was initially above the product to be heated has pivoted so that central part 16 is not situated between the product to be heated and heating device 5. The central part is not heated by the top metal foil and/or does not act as thermal insulator between heating device 5 and the product to be heated.

The cutting of lid 13 to define central part 16 advantageously extends only over a part of the height of the side panel in order to ensure the strength of lid 13, preferably at least 50% of the height of the front panel. It is advantageous to provide for the cutting of the front panel of lid 13 to extend over a part of the width of the front panel, preferentially at least 50% of the width of the front panel to ensure the strength of lid 13. Preferentially, the opening of the front panel is centred with respect to the width of the front panel.

In the illustrated embodiment, the cutting is made so as to define a single area cut in the front panel of lid 13, but a larger number of cuts can be made.

Cutting lid 13 into a central area 16 and a peripheral area 17 enables a heating position to be formed that presents the strength of the closed position and at the same time enables the product to be heated. When the packaging is inserted in the heating area and then removed, the box presents an enhanced strength avoiding having to hold the box underneath the product. The absence of the central area during the heating phase prevents damage to the lid just above the product or the presence of a thermal insulator between the heating device and the product.

Preferentially, central area 16 represents at least 50% of the surface of the top panel of the lid, even more preferentially at least 75% of the surface of the top panel of the lid. In advantageous manner, the central area extends over at least 50% or at least 75% of the width of the top main panel, the width being measured along the pivoting axis of the peripheral area. In advantageous manner, the central area extends over at least 50% or at least 75% of the length of the top main panel, the length being measured along the pivoting axis of the peripheral area.

In the illustrated embodiment, central area 16 and peripheral area 17 have the same hinge and pivot around the same axis of rotation, here the rear panel of the box. In an alternative embodiment, central area 16 and peripheral area 17 are arranged pivoting around two different hinges. For example, the hinge of the peripheral area is arranged on a side panel whereas the hinge of the central area is arranged on the top main panel near the hinge of peripheral area 17. In yet another embodiment, the hinge of the peripheral area is arranged on a side panel whereas the hinge of the central area is arranged on the opposite side panel or on the top main panel near the opposite side panel.

This packaging configuration enables the product to be manufactured and then placed on bottom metal foil 14. Bottom metal foil 14 is then handled to be installed on base 11. The box is closed for performing handling.

To heat the product, a packaging is provided that is advantageously as described in the foregoing. The lid is in the closed position to protect the product by means of the top main panel of the lid.

Central area 16 is moved in order to arrange it in the heating position. The packaging is inserted in the heating area between the inductor and the heating device. The packaging is inserted in the heating area by passing it through the slot. Central area 16 is arranged in the heating position in such a way that central area 16 does not oppose insertion of packaging 10 by striking against error prevention device 6 and/or so that movable pin 7 detects the absence of lid 13 in the heating area.

The product is heated by means of inductor 4 and heating device 5. The product is then removed from the heating area.

Depending on the embodiments, the packaging can be provided with the second metal film or not.

1. Packaging for a food product comprising:
a box made from cardboard material provided with a base and a lid, the lid being fitted pivoting around a hinge fixed to the base, the lid being movable between a closed position and an open position, the lid having a top main panel facing a bottom main panel of the base in the closed position and having side panels;
an electrically conducting foil installed so as to separate the food product and the base;
wherein the lid is cut to define a central area and a peripheral area each arranged pivoting independently with respect to the base, the peripheral area being arranged pivotally around the hinge, the central area being arranged pivotally with respect to the peripheral area and being inscribed inside the peripheral area, the central area facing the electrically conducting foil and extending partly in a front side panel of the lid opposite the side panel supporting the hinge of the peripheral area or in a rear side panel of the lid supporting the hinge of the peripheral area, the central area representing at least 50% of the surface of the top main panel of the lid.

2. Packaging according to claim 1, wherein the central area and the peripheral area are arranged pivoting around the same hinge.

3. Induction furnace for heating a product placed in a packaging provided with a base associated with a lid movable by pivoting with respect to the base, the induction furnace comprising:
a housing defining an insertion slot for inserting the packaging in a heating area,
a bottom inductor and a heating device arranged in the housing and spaced apart from one another to define the heating area,
a detector configured to detect whether the lid of the packaging is present or not, the detector being configured to prevent electric power supply of the bottom inductor and of the heating device when the detector detects that the lid of the packaging is present in the heating area and to allow power supply of the bottom inductor and of the heating device when the detector detects that the lid is not present in the heating area, the detector comprising a movable pin, a control circuit monitoring the movement of the movable pin to deduce the presence or absence of the lid in the heating area therefrom.

4. Induction furnace according to claim 3 wherein the movable pin moves in the heating area in a direction passing via the bottom inductor and the heating device.

5. Induction furnace according to claim 3 wherein the housing defines a guide configured to guide the packaging from the insertion slot to the heating area in a first direction, the movable pin moving in the heating area in the first direction, the movable pin being associated with a spring pushing the movable pin in the direction of the insertion slot so that insertion of the packaging presses on the movable pin.

6. Induction furnace for heating a product placed in a packaging provided with a base associated with a lid movable by pivoting with respect to the base, the induction furnace comprising:
a housing defining an insertion slot for inserting the packaging into a heating area,
a bottom inductor and a heating device spaced apart from one another to define the heating area,
an error prevention device forming a part of the insertion slot, the error prevention device extending from the top surface of the insertion slot to the bottom surface of the slot to prevent insertion of the packaging when the lid is in a position closing the packaging.

7. Method for heating a product comprising the following steps:
providing a packaging according to claim 1 in the closed position,
providing a furnace comprising:
a housing defining an insertion slot for inserting the packaging in a heating area,
a bottom inductor and a heating device arranged in the housing and spaced apart from one another to define the heating area,
a detector configured to detect whether the lid of the packaging is present or not, the detector being configured to prevent electric power supply of the bottom inductor and of the heating device when the detector detects that the lid of the packaging is present in the heating area and to allow power supply of the bottom inductor and of the heating device when the detector detects that the lid is not present in the heating area, the detector comprising a movable pin, a control circuit monitoring the movement of the movable pin to deduce the presence or absence of the lid in the heating area therefrom,
moving the central area from the closed position to the heating position, the peripheral area being in the closed position,
inserting the base and the product in the heating area of the induction furnace by passing through the slot, the central area being outside the heating area,
heating the product.

8. Method for heating a product comprising the following steps:
providing a packaging according to claim 1 in the closed position,
providing a furnace comprising:
a housing defining an insertion slot for inserting the packaging into a heating area,
a bottom inductor and a heating device spaced apart from one another to define the heating area,
an error prevention device forming a part of the insertion slot, the error prevention device extending from the top surface of the insertion slot to the bottom surface of the slot to prevent insertion of the packaging when the lid is in a position closing the packaging,
moving the central area from the closed position to the heating position, the peripheral area being in the closed position,
inserting the base and the product in the heating area of the induction furnace by passing through the slot, the central area being outside the heating area,
heating the product.
